(19) United States
(12) Patent Application Publication
(10) Pub. No.: US 2005/0242908 A1
(43) Pub. Date: Nov. 3, 2005

(54) Light pole with integral circuit breaker

(76) Inventors: Gord Alan Shepstone, Burlington (CA); Robert Noel Conway, Guelph (CA); Deborah Anne Holland, Hamilton (CA); Robert Joseph Laframboise, Burlington (CA); Helen Mary Veldhuis, Dundas (CA); Ross William Murray, Burlington (CA)

Correspondence Address: Martin J. Moran;Eaton Electrical, Inc., Technology & Quality Center, 170 Industry Drive, RIDC Park West, Pittsburgh, PA, 15275-1032, US

(21) Appl. No.: 10/836,612

(22) Filed: Apr. 30, 2004

(51) Int. Cl. H01H 73/00

(52) U.S. Cl. 335/202

(57) ABSTRACT

A modular circuit breaker assembly structured to be disposed within a light pole that includes a housing assembly, a mounting assembly disposed within the housing assembly, a circuit breaker coupled to the mounting assembly, and a plurality of conductors. The light pole has an elongated body with a cavity. Within the light pole cavity is a line conductor and a load conductor, each of which terminate in a coupling device. The modular circuit breaker assembly plurality of conductors include at least one line conductor and at least one load conductor, the modular circuit breaker assembly at least one line conductor and modular circuit breaker assembly at least one load conductor coupled to, and in electrical communication with, the circuit breaker. Thus, the modular circuit breaker assembly may be installed as a unit within the light pole cavity with the circuit breaker assembly line conductor coupled in electrical communication with the light pole line conductor and the circuit breaker assembly load conductor coupled in electrical communication with the light pole load conductor.

### BACKGROUND OF THE INVENTION

1. Field of the Invention

The present invention relates to light poles and, more specifically, to a light pole having an integral circuit breaker.

2. Background Information

Street lights are typically supported by a light pole. Light poles, which may also support other electrical components such as cameras, must have a means for disconnecting from the power system. Traditionally, the disconnect means was a circuit breaker located on a load center disposed in a separate enclosure.

There are, however, disadvantages to having a circuit breaker disposed in a separate enclosure. The separate enclosure occupies more space. This is especially a problem in crowded cities. A separate load center is also a target for vandalism, both unsightly marks on the housing extensor as well as substantive damage to the components enclosed therein. External units are also often damaged by accident, e.g., car accident, or collision with a snow plow.

There is, therefore, a need for a light pole having an integral circuit breaker.

There is a further need for a modular circuit breaker assembly that may be easily installed in, and removed from, a light pole.

### SUMMARY OF THE INVENTION

These needs, and others, are met by the present invention which provides a modular circuit breaker assembly that is structured to be disposed within a light pole. The circuit breaker assembly includes a housing assembly enclosing a mounting assembly, a circuit breaker, and a plurality of conductors. The mounting assembly includes elongated stabs supporting lugs. The neutral lug is disposed outside the housing. This configuration allows the circuit breaker assembly to have a more narrow profile than prior art circuit breaker assemblies.

The modular circuit breaker assembly each conductor includes a proximal end coupled to the circuit breaker or neutral lug, and a distal end having a coupling device. As such, the modular circuit breaker assembly may be coupled/decoupled as a unit from the line and load conductors within a light pole.

The invention further provides for a light pole having a circuit breaker assembly access panel. The access panel allows a technician access to the cavity within the light pole. Within the cavity are the line and load conductors having coupling devices structured to engage the circuit breaker assembly and a light pole mounting to which the circuit breaker assembly is attached.

### BRIEF DESCRIPTION OF THE DRAWINGS

A full understanding of the invention can be gained from the following description of the preferred embodiments when read in conjunction with the accompanying drawings in which:

FIG. 1 is a side view of a street light. FIG. 1A is a detailed view of the modular circuit breaker assembly disposed in the light pole.

FIG. 2 is an isometric view of the modular circuit breaker assembly.

FIG. 3 is an isometric view of the modular circuit breaker assembly with the cover assembly and side plates removed.

FIG. 4 is a side view of the modular circuit breaker assembly with the cover assembly and side plates removed.

FIG. 5 is a top view of the modular circuit breaker assembly with the cover assembly and side plates removed and where the circuit breaker is a two pole circuit breaker.

FIG. 6 is an isometric view of the modular circuit breaker assembly with the cover assembly and side plates removed and where the circuit breaker is a two pole circuit breaker.

### DESCRIPTION OF THE PREFERRED EMBODIMENTS

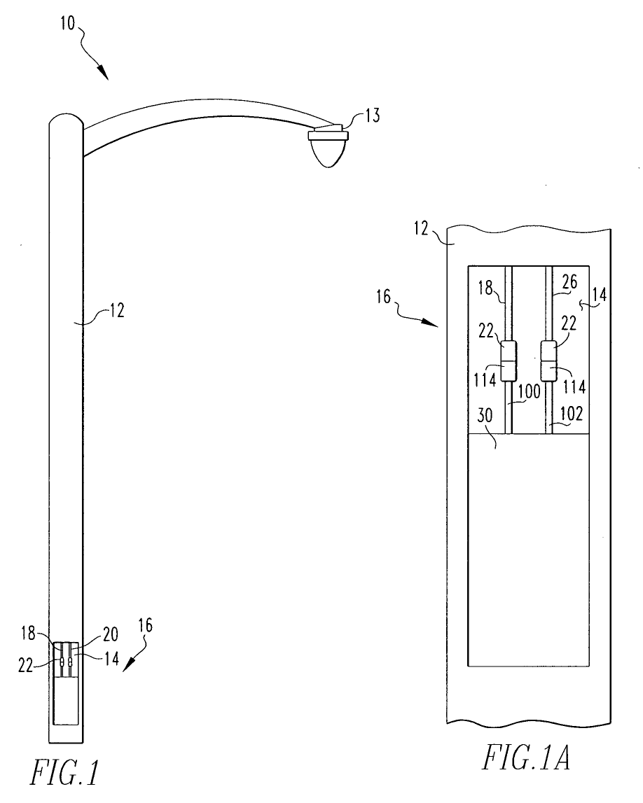

As shown in FIG. 1, a light pole 10 includes an elongated body 12 having a cavity 14 therein. The body 12 is structured to support an electrical component 13 such as, but not limited to, a street light or a camera. Accordingly, the body 12 includes a plurality of conductors 16 extending at least from the cavity 14 to the top of the body 12. The pole conductors 16 preferably include at least one line conductor 18 and at least one load conductor 20. The line conductor 18 is in electrical communication with a power grid and the load conductor 20 is in electrical communication with the street light or other electrical components 13. The pole conductors 16 have coupling devices 22 that are structured to engage the modular circuit breaker assembly 30 (discussed below). Within the cavity 14 are attachment points (not shown) structured to be engaged by the modular circuit breaker assembly 30.

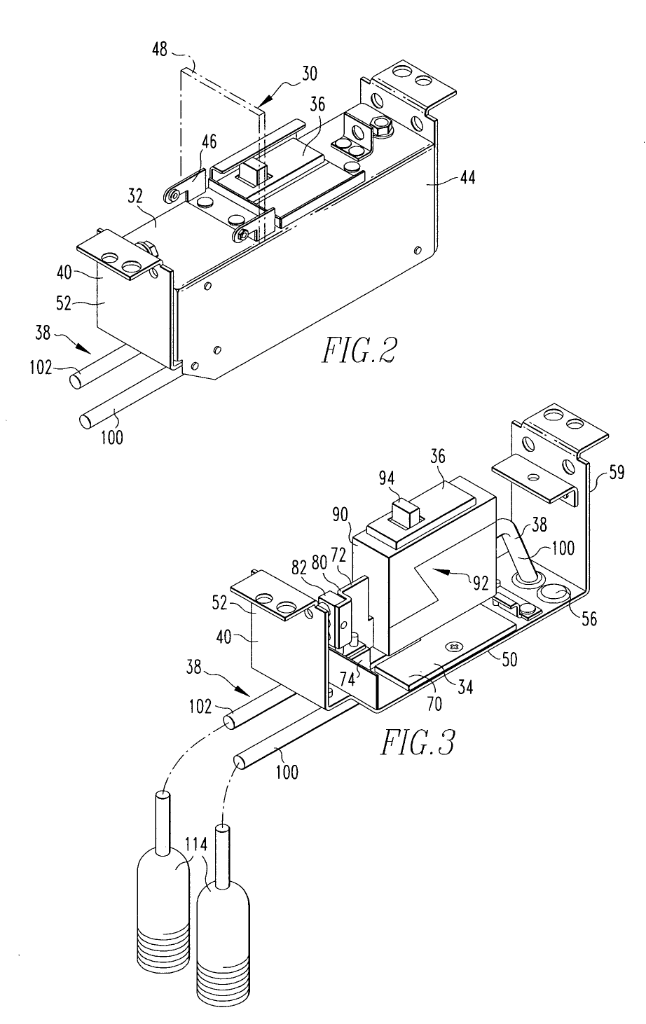

As shown in FIGS. 2-4, a modular circuit breaker assembly 30 includes a housing assembly 32, a mounting assembly 34, a circuit breaker 36, and a plurality of conductors 38. The housing assembly 32, shown more completely in FIG. 2, includes a U-shaped member 40, side plates 42, 44, a cover assembly 46, and an external neutral lug 39. The U-shaped member 40 includes a bight portion 50, and two legs 52, 54 extending generally perpendicular to the bight portion 50. The bight portion 50 is elongated and includes a plurality of openings 56. The openings 56 include at least a line conductor opening 58, and a load conductor opening 60. The side plates 42, 44, are disposed on opposite lateral sides of the U-shaped member 40. The cover assembly 46 extends across the top of the U-shaped member 40 and may include a flip-up portion 48 that allows access to the top of the circuit breaker 36.

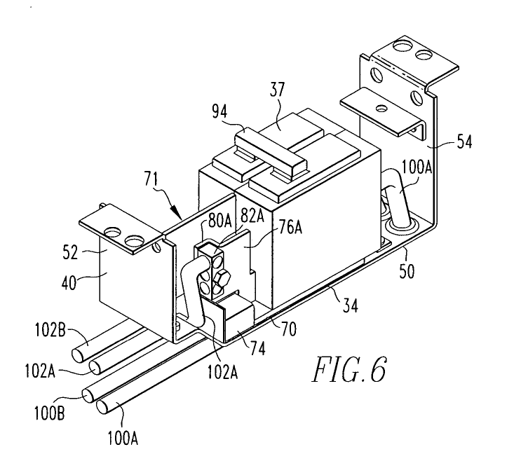

The mounting assembly 34 includes an insulated planar member 70 and at least one stab assembly 72. The insulated planar member 70 is made from a nonconductive material, such as, but not limited to, GPO3. The insulated planar member 70 is generally disposed on the bight portion 50 and acts as a platform upon which the circuit breaker 36 is disposed. The insulated planar member 70 may include a thicker support block 74. The support block 74 supports the stab assembly 72. The stab assembly 72 includes at least one blade-like stab 76. Each stab 76 is a thin, elongated conductive member having a longitudinal axis generally parallel to the longitudinal axis of the bight portion 50 and extending outwardly from the bight portion 50. Each stab 76 has a proximal end 78 that is structured to be engaged by the circuit breaker 36. Each stab 76 also has a distal end 80 which supports a load lug 82. The load lug 82 is structured to be coupled to a circuit breaker assembly load conductor 102 (described below). Generally, there is one stab 76 per pole of the circuit breaker 36. Thus, if the circuit breaker 36 is a single pole circuit breaker, there is only one stab 76. If, as shown in FIGS. 5 and 6, the circuit breaker 37 is a two-pole circuit breaker, there are two stabs 76A, 76B. Where there are two stabs 76A, 76B the insulated planar member 70 may also include a sheet-like stab insulator portion 71. The stab insulator 71 extends between the stabs 76A, 76B. As used hereinafter, when discussing the two-pole circuit breaker 37 shown in FIGS. 5 and 6, it is understood that a reference number followed by the letters “A” or “B” indicates a similar component associated with one pole of the two-pole circuit breaker 37.

As shown in FIGS. 3, the circuit breaker 36 includes a housing 90 that encloses a pair of separable contacts 92 (shown schematically). The contacts 92 are coupled to an operating mechanism (not shown), as is known in the art, and are structured to separate upon an overcurrent condition. Additionally, the operating mechanism may be actuated manually by an external handle 94. The circuit breaker 36 is structured to be coupled in electrical communication to the stab proximal end 78. The circuit breaker 36 is further structured to be coupled in electrical communication with at least one circuit breaker assembly line conductor 100 discussed below. The circuit breaker 36 is further coupled to, and in electrical communication with, the neutral lug 39.

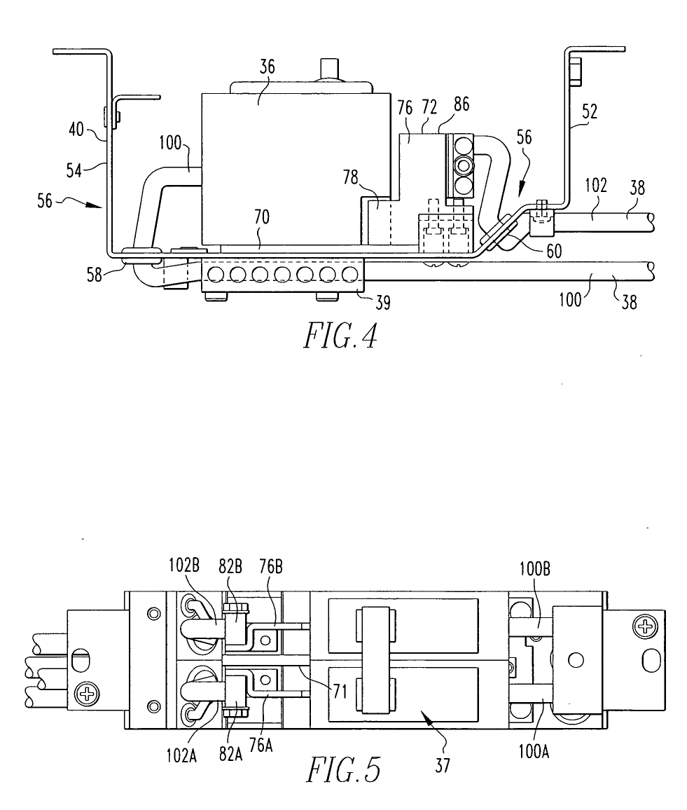

As shown in FIG. 4, the plurality of conductors 38 includes at least one line conductor 100 and at least one load conductor 102. There may also be a fused load line 104 coupled to ballast (not shown) as known in the art. Generally, there is one line conductor 100 and one load conductor 102 for each pole of the circuit breaker 36. Thus, as shown in FIGS. 2-4, for the single pole circuit breaker 36, there is only one line conductor 100 and one load conductor 102. For the two-pole circuit breaker 37, shown in FIG. 5, there are two line conductors 100A, 100B and two load conductors 102A, 102B. Each line conductor 100 has a proximal end 106, which is structured to be coupled to the circuit breaker 36, and a distal end 108. Each load conductor 102 has a proximal end 110, which is structured to be coupled to the load lug 82, and a distal end 112. Each distal end 108, 112 includes a coupling device 114 that is structured to be coupled to the pole line and load conductors 18, 20.

The modular circuit breaker assembly 30 is assembled as follows. The mounting assembly 34 is coupled to the housing assembly 32 with the insulated planar member 70 coupled to the inner side of the U-shaped member bight portion 50. The stab 76 longitudinal axis extends generally parallel to the longitudinal axis of the bight portion 50 and the body of the stab 76 extends outwardly from the bight portion 50. The stab 76, and more specifically the load lug 82, is disposed adjacent to the load conductor opening 60. The neutral lug 39 is coupled to the lower side of the U-shaped member bight portion 50. The circuit breaker 36 is mechanically coupled to the insulated planar member 70. The circuit breaker 36 is further coupled to, and in electrical communication with, the stab 76. The line conductor 100 extends, generally along the lower side of the U-shaped member bight portion 50. The line conductor proximal end 106 extends through the line conductor opening 58 and is further coupled to the circuit breaker 36. The load conductor proximal end 110 extends through the load conductor opening 60 and is coupled to the load lug 82. The side plates 42, 44 are coupled to the U-shaped member 40, generally on either side of the circuit breaker 36. The cover assembly 46 is coupled to the U-shaped member 40 and is disposed, generally, over top of the circuit breaker 36. In this configuration, the housing assembly 32 forms an enclosure having an outer side and an inner side. The circuit breaker 36 is enclosed within the housing assembly 32 with the distal ends 108, 112 of the circuit breaker assembly line and load conductors 100, 102, and the coupling devices 114, extending outside of the housing assembly 32. Further, the neutral lug 39 is also disposed outside of the housing assembly 32. Thus, the modular circuit breaker assembly 30 may be installed as a unit within the light pole cavity 14 by attaching the line and load conductor coupling devices 114 to the light pole conductor coupling devices 22 and the housing assembly 32 to the attachment points. Additionally, this configuration allows the modular circuit breaker assembly 30, and, more specifically the housing assembly 32, to have a width between about 1.9 inches and 2.25 inches inches, and more preferably about 2.1 inches. Thus, the modular circuit breaker assembly 30 is sized to fit within the light pole body 12.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

1. A modular circuit breaker assembly structured to be disposed within a light pole, said light pole having an elongated body with a cavity, a line conductor and a load conductor, said light pole line and load conductors terminating in a coupling device, said modular circuit breaker assembly comprising:
a housing assembly;
a mounting assembly disposed within said housing assembly;
a circuit breaker coupled to said mounting assembly;
a plurality of conductors, including at least one line conductor and at least one load conductor, said at least one line conductor and at least one load conductor coupled to, and in electrical communication with, said circuit breaker;
whereby said modular circuit breaker assembly may be installed as a unit within said light pole cavity with said circuit breaker assembly line conductor coupled in electrical communication with said light pole line conductor and said circuit breaker assembly load conductor coupled in electrical communication with said light pole load conductor.

2. The modular circuit breaker assembly of claim 1, wherein,
said mounting assembly includes at least one elongated stab assembly;
said circuit breaker is coupled in electrical communication with said at least one stab assembly; and
said circuit breaker assembly at least one load conductor is coupled to said at least one stab assembly.

3. The modular circuit breaker assembly of claim 2, wherein said at least one stab assembly includes a stab and a load lug, said stab having a distal end and said load lug being coupled to said stab distal end.

4. The modular circuit breaker assembly of claim 3, further including a neutral lug, said neutral lug coupled to said housing assembly and lug in electrical communication with said circuit breaker.

5. The modular circuit breaker assembly of claim 4, wherein said mounting assembly includes an insulated planar member, said insulated planar member disposed between said housing assembly and said circuit breaker.

6. The modular circuit breaker assembly of claim 4, wherein said insulated planar member is made from GPO3.

7. The modular circuit breaker assembly of claim 2, wherein
said circuit breaker is a two-pole circuit breaker;
said at least one stab includes two stabs; and
said mounting assembly includes a stab insulator extending between said stabs.

8. The modular circuit breaker assembly of claim 1, wherein,
said housing assembly forms an enclosure having an outer side and an inner side; and
said housing assembly further including a neutral lug, said neutral lug disposed on the outer side of said housing assembly outer side.

9. The modular circuit breaker assembly of claim 1, wherein,
said housing assembly forms an enclosure having an outer side and an inner side;
said circuit breaker assembly line and load conductors have a proximal end and a distal end;
each said proximal end coupled to said circuit breaker;
each said circuit breaker assembly line and load conductor distal end extending to the outer side of said housing assembly and including a coupling device structured to engage, respectively, said light pole conductor line and load coupling device.

10. The modular circuit breaker assembly of claim 1, wherein said housing assembly has a width between about 1.9 inches and 2.25 inches.

11. A light pole comprising:
an elongated body having a cavity;
a line conductor;
a load conductor;
said light pole line and load conductors each terminating in a coupling device;
a modular circuit breaker assembly comprising:
a housing assembly;
a mounting assembly disposed within said housing assembly;
a circuit breaker coupled to said mounting assembly;
a plurality of conductors, including at least one line conductor and at least one load conductor, said at least one line conductor and at least one load conductor coupled to, and in electrical communication with, said circuit breaker; and
whereby said modular circuit breaker assembly may be installed as a unit within said light pole cavity with said circuit breaker assembly line conductor coupled in electrical communication with said light pole line conductor and said circuit breaker assembly load conductor coupled in electrical communication with said light pole load conductor.

12. The light pole of claim 11, wherein,
said mounting assembly includes at least one elongated stab assembly;
said circuit breaker is coupled in electrical communication with said at least one stab assembly; and
said circuit breaker assembly at least one load conductor is coupled to said at least one stab assembly.

13. The light pole of claim 12, wherein said at least one stab assembly includes a stab and a load lug, said stab having a distal end and said load lug being coupled to said stab distal end.

14. The light pole of claim 13, further including a neutral lug, said neutral lug coupled to said housing assembly and lug in electrical communication with said circuit breaker.

15. The light pole of claim 14, wherein said mounting assembly includes an insulated planar member, said insulated planar member disposed between said housing assembly and said circuit breaker.

16. The light pole of claim 14, wherein said insulated planar member is made from GPO3.

17. The light pole of claim 12, wherein
said circuit breaker is a two-pole circuit breaker;
said at least one stab includes two stabs; and
said mounting assembly includes a stab insulator extending between said stabs.

18. The light pole of claim 11, wherein,
said housing assembly forms an enclosure having an outer side and an inner side; and
said housing assembly further including a neutral lug, said neutral lug disposed on the outer side of said housing assembly outer side.

19. The light pole of claim I 1, wherein,
said housing assembly forms an enclosure having an outer side and an inner side;
said circuit breaker assembly line and load conductors have a proximal end and a distal end;
each said proximal end coupled to said circuit breaker;
each said circuit breaker assembly line and load conductor distal end extending to the outer side of said housing assembly and including a coupling device structured to engage, respectively, said light pole conductor line and load coupling device.

20. The light pole of claim 11, wherein said housing assembly has a width between about 1.9 inches and 2.25 inches.
